(19) United States
(12) Patent Application Publication
(10) Pub. No.: US 2024/0182261 A1
(43) Pub. Date: Jun. 6, 2024

(54) ELEVATOR SYSTEM

(71) Applicant: KONE Corporation, Helsinki (FI)

(72) Inventors: Ari KATTAINEN, HELSINKI (FI); Henry SILVENNOINEN, HELSINKI (FI); Mika BELOV, HELSINKI (FI)

(73) Assignee: KONE Corporation, Helsinki (FI)

(21) Appl. No.: 18/442,738

(22) Filed: Feb. 15, 2024

Related U.S. Application Data
(63) Continuation of application No. PCT/EP2021/075799, filed on Sep. 20, 2021.

(51) Int. Cl. B66B 1/44; B66B 1/34; B66B 3/00; B66B 5/00

(52) U.S. Cl. CPC B66B 1/44; B66B 1/3476; B66B 1/3492; B66B 5/0012; B66B 3/00; B66B 2201/104

(57) ABSTRACT

An elevator system includes a device for obtaining an indication of a heavy object to be transported with the elevator system; a device for allocating an elevator car to transport the heavy object; and a device for activating, in response to the indication, at least one pre-emptive action associated with the allocated elevator car in an adjustment mode. The adjustment mode is configured to substantially maintain a vertical position of the elevator car in an elevator shaft when the heavy object is loaded into the elevator car.

### TECHNICAL FIELD

The present application relates to the field of elevator systems.

### BACKGROUND

Elevators in an elevator system can be used to transports different types of loads. A typical load comprises one or more passengers travelling to one or more floors. In addition to human passengers, elevators can be used to transport various objects, which may be heavy. For example, a single object to be transported with an elevator may weigh several hundreds of kilograms or even more. When the object is then pushed into an elevator car, a sudden weigh change experienced by the elevator car may cause the elevator car to slightly sinkin an elevator shaft. In other words, the floor level of the elevator car will be lower than the floor level of the building floor. This may be problematic, for example, in a situation in which an object is carried by a troller, and when the front wheels of the troller land on the elevator car floor, the elevator car moves downwards in the elevator shaft due to suddenly increased significant load. If a person handling the troller then, for example, changes his/her mind and tries to back off from the elevator car, this may not be possible any more as there is a significant threshold from the elevator car to the building floor.

Thus, it would be beneficial to have a solution that would alleviate at least one of these drawbacks.

### SUMMARY

According to an aspect, there is provided an elevator system. The elevator system comprises means for obtaining an indication of a heavy object to be transported with the elevator system, means for allocating an elevator car to transport the heavy object based on the indication, and means for activating, in response to the indication, at least one pre-emptive action associated with the allocated elevator car in an adjustment mode, wherein the adjustment mode is configured to substantially maintain a vertical position of the elevator car in an elevator shaft when the heavy object is loaded into the elevator car.

In an implementation form, the at least one pre-emptive action comprises an activation of a pawl device.

In an implementation form, the adjustment mode comprises a precision mode, and wherein in the precision mode the means for activating are configured to, as the at least one pre-emptive action: set a torque to a motor associated with the elevator car in order to keep the elevator car in place in the elevator shaft, open machinery brakes at least partially, and maintain the position of the elevator car in the elevator shaft with the motor based on information from at least one sensor, when the load carried by the elevator car changes.

In an implementation form, the at least one sensor comprises at least one of a position sensor, a strain sensor, a torque sensor and a load sensor.

In an implementation form, the means for obtaining the indication of the heavy object are configured to obtain the indication from a system external to the elevator system.

In an implementation form, wherein the means for obtaining comprise a sensor system configured to obtain image data provided by at least one camera, and process the image data in order to identify the heavy object.

In an implementation form, the sensor system is configured to identify the heavy object by identifying from the image data an identifier associated with the object.

In an implementation form, the elevator system comprises the at least one camera.

In an implementation form, the at least camera comprises a camera configured in at least one of the following: a car operating panel, a car display, an elevator signalization device, an info display, a destination operating panel, and a floor display.

In an implementation form, the sensor system and the at least one camera are arranged in a single communication segment in the elevator system.

In an implementation form, the sensor system comprises multiple analysis units configured in different locations in the elevator system.

In an implementation form, an analysis unit of the multiple analysis units and at least one camera are arranged in a single communication segment in the elevator system.

In an implementation form, the means for obtaining the indication of the heavy object are configured to obtain the indication together with an elevator call.

In an implementation form, the indication comprise the mass of the object.

In an implementation form, the means for obtaining the indication of the heavy object are configured to obtain the indication via a radio frequency transmission.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1A illustrates an elevator system according to an example embodiment.

FIG. 1B illustrates an elevator system according to another example embodiment.

FIG. 2 illustrates an elevator communication system according to an example embodiment.

FIG. 3A illustrates an elevator lobby arrangement according to an example embodiment.

FIG. 3B illustrates an elevator lobby arrangement according to an example embodiment.

### DETAILED DESCRIPTION

The following description illustrates an elevator system that is configured to adapt an operation of an elevator car in response to obtaining an indication of a heavy object to be transported with the elevator. The elevator system is configured to activate, in response to the indication, at least one pre-emptive action associated with the elevator car in an adjustment mode, wherein the adjustment mode is configured to substantially maintain a vertical position of the elevator car in an elevator shaft when the heavy object is loaded into the elevator car. The elevator system thus comprises means for obtaining an indication of a heavy object to be transported with the elevator system, means for allocating an elevator car to transport the heavy object, and means for activating, in response to the indication, at least one pre-emptive action associated with the allocated elevator car in an adjustment mode, wherein the adjustment mode is configured to substantially maintain a vertical position of the elevator car in an elevator shaft when the heavy object is loaded into the elevator car. The illustrated solution may enable, for example, that the elevator system is able to maintain the position of the elevator car in the elevator shaft substantially constant even if the heavy object is loaded into the elevator car.

In an example embodiment, the various embodiments discussed herein may be used in an elevator system comprising an elevator that is suitable and may be used for transferring passengers and other objects between landing floors of a building in response to service requests.

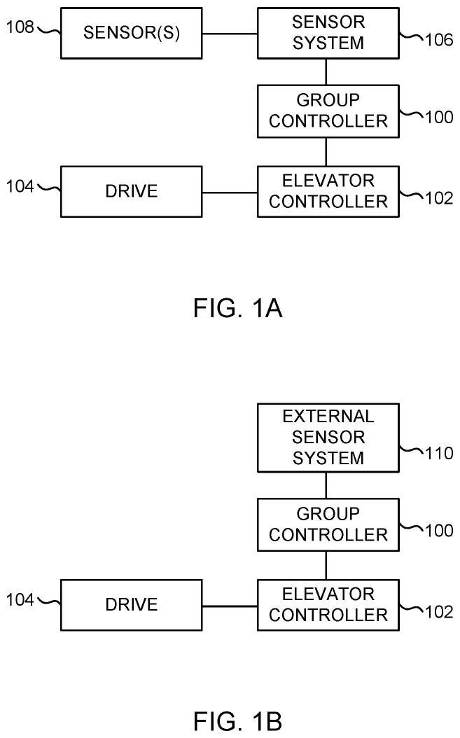

FIG. 1A illustrates an elevator system according to an example embodiment.

The elevator system may comprise one or more elevator cars with at least one associated elevator controller 102. The elevator system may also comprise a group controller 100 configured to provide control of the elevator cars in a group level. The elevator controller 102 is connected to a drive 104 that controls a motor to move the elevator car in the elevator shaft. A sensor system 106 may be connected to at least one of the group controller 100 and the elevator controller 102. One or more sensors 108, for example, cameras, may be part of the sensor system 106 or separate elements from the sensor system 106.

Connections between the various elements of the elevator system may be direct or indirect. Indirect may refer, for example, to a solution in which an elevator communication system may be used to transfer information about the elevator system, and different types of communication buses and other network elements, for example, point-to-point ethernet buses, multi-drop ethernet buses and switches, may be used to implement the data communication. Thus, indirect may mean that elements may be communicatively connected to each other.

The elevator system comprises means for obtaining an indication of a heavy object to be transported with the elevator system, means for allocating an elevator car to transport the heavy object, and means for activating, in response to the indication, at least one pre-emptive action associated with the allocated elevator car in an adjustment mode, wherein the adjustment mode is configured to substantially maintain a vertical position of the elevator car in an elevator shaft when the heavy object is loaded into the elevator car. The illustrated solution may enable, for example, that the elevator system is able to maintain the position of the elevator car in the elevator shaft substantially constant even if the heavy object is loaded into the elevator car.

In an example embodiment, the sensor system 106 may act as means for obtaining the indication and be configured to identify the heavy object based on image data from at least one camera 108. The identification may thus be based, for example, an image recognition system or a machine vision system. The sensor system 106 may identify, for example, based on the size of the object that the object is a “heavy object”. In another example embodiment, the sensor system may identify some identifier from the image data, for example, a text, an object identifier, a QR code, a bar code, and then based on the identifier obtain additional information about the weight of the object.

In an example embodiment, the sensor system 106 may comprise one or more elements that are configured to receive and/or transmit radio frequency (RF) based data. Thus, the object may comprise, for example, a RFID tag which then wirelessly communicates with the sensor system 106 to enable identification of the object as a heavy object.

When the existence of a (possibly) heavy object has been identified, the group controller 100 may act as the means for allocating the elevator car. Thus, when there are more than one elevator in the elevator system, the group controller 100 may first be configured to select a suitable elevator for the object, and then allocate an elevator call for the selected elevator. If the elevator system comprises only one elevator car, a separate group controller may not be needed, and the allocation may be implemented, for example, by the elevator controller 102. As the group controller 100 is aware of the overall traffic situation with the elevators and knows if the elevators have different transport capabilities, the group controller 100 is able to allocate an elevator car suitable for transporting the heavy object.

When the elevator car has been allocated, the elevator system may activate, in response to the indication, at least one pre-emptive action associated with the allocated elevator car in an adjustment mode. In the adjustment mode the elevator system may be configured to maintain a vertical position of the elevator car in an elevator shaft when the heavy object is loaded into the elevator car. In other words, even if the load experience by the elevator car increases, the elevator car does not slide vertically lower in the elevator shaft due to the increased weight. In an example embodiment, the elevator controller 102 or the drive 104 may act as the means for activating, in response to the indication, the at least one pre-emptive action associated with the allocated elevator car in the adjustment mode.

In an example embodiment, the at least camera 108 may comprise a camera configured in at least one of the following: a car operating panel, a car display, an elevator signalization device, an info display, a destination operating panel, and a floor display.

FIG. 1B illustrates an elevator system according to another example embodiment.

The elevator system illustrated in FIG. 1B differs from the elevator system illustrated in FIG. 1A in that in the elevator system of FIG. 1B the group controller 100 may be configured to receive the indication of the heavy object to be transported with the elevator system from an external sensor system 110. The external sensor system 110 may be a system that is not part of the elevator system itself, but is connected to the elevator system via an application programming interface (API) or any other interface. Sensor or image data may have been obtained by the external sensor system 110, and it may process the data to identify the heavy object. The group controller 100 may then obtain only an indication of the heavy objects. In an example embodiment, some additional information, for example, relating to the size and/or weight of the object, may be received from the external sensor system 110.

In an example embodiment, the means for obtaining the indication of the heavy object may be configured to obtain the indication together with an elevator call. For example, when a passenger whose intention is to bring a heavy object into an elevator car, makes an elevator call, the passenger may use a special “heavy object call” and provide an additional indication about the heavy object, when making the elevator call, for example, using a destination operating panel (DOP).

In an example embodiment of FIG. 1A or FIG. 1B, the at least one pre-emptive action may comprise an activation of a pawl device. The pawl device is a piece of safety equipment, and its primary function is to stop the elevator from dropping when triggered, for example, in an emergency situation. In the disclosed solution, the pawl device may be used to provide a similar end result in a heavy object implementation.

In an example embodiment of FIG. 1A or FIG. 1B, the adjustment mode may comprise a precision mode, and in the precision mode the means for activating are configured to, as the at least one pre-emptive action, set a torque to a motor associated with the elevator car in order to keep the elevator car in place in the elevator shaft, open machinery brakes at least partially, and maintain the position of the elevator car in the elevator shaft with the motor based on information from at least one sensor, when the load carried by the elevator car changes. The information may be provided, for example, by at least one of a position sensor, a strain sensor, a torque sensor and a load sensor. In other words, the motor associated with the elevator car is operated so that the elevator car keeps its position in the elevator shaft regardless of the increased weight carried by the elevator car. In another example embodiment, the elevator system may be configured to maintain the position of the elevator car in the elevator shaft with the motor based on the need for torque seen by the motor. For example, if a torque needed to maintain a motor axle angle increases, the motor axle may be rotated so that the length of ropes between the motor and the elevator car decreases. And, if the torque needed to maintain the motor axle angle decreases, the motor axle may be rotated so that the length of ropes between the motor and the elevator car increases.

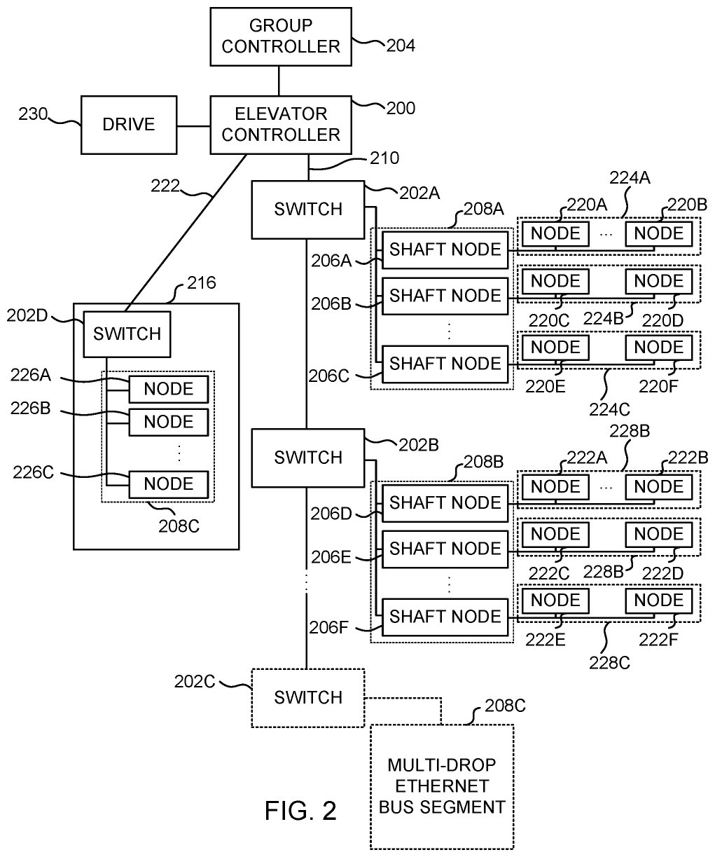

FIG. 2 illustrates an elevator communication system of an elevator system according an example embodiment. The elevator communication system may comprise similar elements than illustrated in FIGS. 1A and 1B. The elevator communication system comprises an elevator controller 200 connected to a group controller 204. The elevator communication system may further comprise one or more multi-drop ethernet bus segments 208A, 208B, 208C, 224A, 224B, 224C, 228A, 228B, 228C reachable by the elevator controller 200, and a plurality of elevator system nodes 206A-206F, 220A-220F, 222A-222F, 226A-226C configured to communicate via the multi-drop ethernet bus segments 208A, 208B, 208C, 224A, 224B, 224C, 228A, 228B, 228C, wherein the elevator controller 200 is reachable by the elevator system nodes 206A-206F, 220A-220F, 222A-222F, 226A-226C via the multi-drop ethernet bus segments 208A, 208B, 208C, 224A, 224B, 224C, 228A, 228B, 228C.

In an example embodiment, the elevator communication system may comprise a point-to-point ethernet bus 210 and at least one connecting unit 202A, 202B, 202C comprising a first port connected to the multi-drop ethernet bus segment 208A, 208B, 208C and a second port connected to the point-to-point ethernet bus 210. Thus, by using the connecting units 202A, 202B, 202C one or more multi-drop ethernet bus segments 208A, 208B, 208C may be connected to the point-to-point ethernet bus 210. The connecting unit 202A, 202B, 202C may refer, for example, to a switch, a hub or a router. Further, the point-to-point ethernet bus 210 may be connected to the elevator controller 200. The point-to-point ethernet bus 210 may be, for example, 100BASE-TX or 10BASET1L point-to-point ethernet bus. The multi-drop ethernet bus segments 208A, 208B, 208C may comprise, for example, 10BASE-T1S multi-drop ethernet bus.

In an example embodiment, an elevator system node 220A-220F, 222A-228C may be configured to interface with at least one of an elevator fixture, an elevator sensor, an elevator safety device, and an elevator control device. Further, in an example embodiment, power to the nodes may be provided with the same cabling.

The elevator communication system may comprise an elevator safety controller. The elevator safety controller may be connected to the point-to-point ethernet bus 210 via a connecting unit. This means that the elevator system nodes 206A-206F, 220A-220F, 222A-222F, 226A-226C may send information to the elevator safety controller and vice versa via the common point-to-point ethernet bus 210. For example, the elevator system nodes 206A-206F, 220A-220F, 222A-222F, 226A-226C may send information, for example, from sensors or fixtures to the elevator controller 200 or the elevator safety controller 204 and receive information therefrom to control, for example, actuators configure fixtures etc. At least some of the elevator system nodes 206A-206F, 220A-220F, 222A-222F, 226A-226C may be safety nodes in accordance with IEC61508 SIL level 3, having a safety processing unit and a separate communication controller. Data of the safety processing unit may be sent only to the elevator safety controller. The safety nodes may be configured to interface with elevator safety devices, such as safety sensors or safety contacts indicating elevator safety, for example, landing door contacts, door lock contacts, contact of overspeed governor, buffer contacts etc. The safety nodes may be configured to communicate with the elevator safety controller. To establish safe communication, different kind of data checks, such as checksums, error detection and/or correction algorithms etc. may be used in the communication.

The elevator communication system may further comprise an elevator drive 230 connected to the elevator controller 200. Further, the elevator communication system may comprise a network interface unit communicatively connected to the elevator controller 200, the network interface unit enabling a connection to an external communication network. The network interface unit may comprise, for example, a router or a gateway.

The elevator communication system may further comprise a point-to-point ethernet bus 222 that provides a connection to an elevator car 216 and to various elements associated with the elevator car 216. The elevator car 216 may comprise a connecting unit 202D, for example, a switch, to which one or more elevator car nodes 226A, 226B, 226C may be connected. In an example embodiment, the elevator car nodes 226A, 226B, 226C can be connected to the connecting unit 202D via a multi-drop ethernet bus segment 208C, thus constituting an elevator car segment. In an example embodiment, the point-to-point-ethernet bus 222 is located in the travelling cable of the elevator car 216.

By implementing communication within the elevator communication system using at least one point-to-point ethernet bus and at least one multi-drop ethernet bus segment, various segments can be formed within the elevator communication system. For example, the elevator system nodes 220A, 220B may form a first landing segment 224A, the elevator system nodes 220C, 220D may form a second landing segment 224B, the elevator system nodes 220D, 220F may form a third landing segment 224C, the shaft nodes 206A, 206B, 206C may form a first shaft segment 208A, the shaft nodes 206D, 206E, 206F may form a second shaft segment 208B, and the elevator car nodes 226A, 226B, 226C may form an elevator car segment 208C. Each of the segments 208A, 208B, 208C may be implemented using separate multi-drop ethernet buses.

As illustrated in FIG. 2, the shaft nodes 206A, 206B, 206C may interconnect the shaft segment 208A to which the shaft nodes 206A, 206B, 206C are connected to and the landing segments 224A, 224B, 224C. In other words, the shaft nodes 206A, 206B, 206C may comprise or may act as a switch to the landing segments 224A, 224B, 224C. This may enable a simple solution for adding new elevator system nodes to the elevator communication system. This may also enable a solution in which a single elevator system node may act as a switch or a repeater to another multi-drop ethernet bus segment to which nearby elevator system elements, for example, a call button or buttons, a display or displays, a destination operating panel or panels, a camera or cameras, a voice intercom device etc.

In an example embodiment, the sensor system 106 and the at least one sensor 108 may be arranged in a single communication segment in the elevator system. The sensor system 106 may be configured to obtain image data provided by at least one camera, process the image data in order to identify the heavy object, and provide the indication to the group controller 204. For example, the nodes 220A, 220B may comprises one or more sensors and the sensor system forming the landing segment 224A. In another example embodiment, the shaft node 208A may act as the sensor system. This means that, if the cameras transmit image data to the landing segment 224A, the data transmission happens only within this segment and does not cause any data transmission load to other ethernet segments.

In an example embodiment, the sensor system 106 may comprise multiple analysis units configured in different locations or ethernet segments in the elevator system. In other words, each segment may comprise a separate analysis unit configured to analyze image data transmitted in the corresponding segment. An analysis unit may be configured to analyze the image data in more detail (for example, by performing image recognition) in order to reach a decision based on the image data. In other words, the image data may be locally (i.e. within a segment) analyzed and only the results of the analysis may be forwarded further, for example, to an elevator controller. This enables a solution in which the data transmission happens only within corresponding segments and does not cause any unnecessary image data transmission load to other ethernet segments.

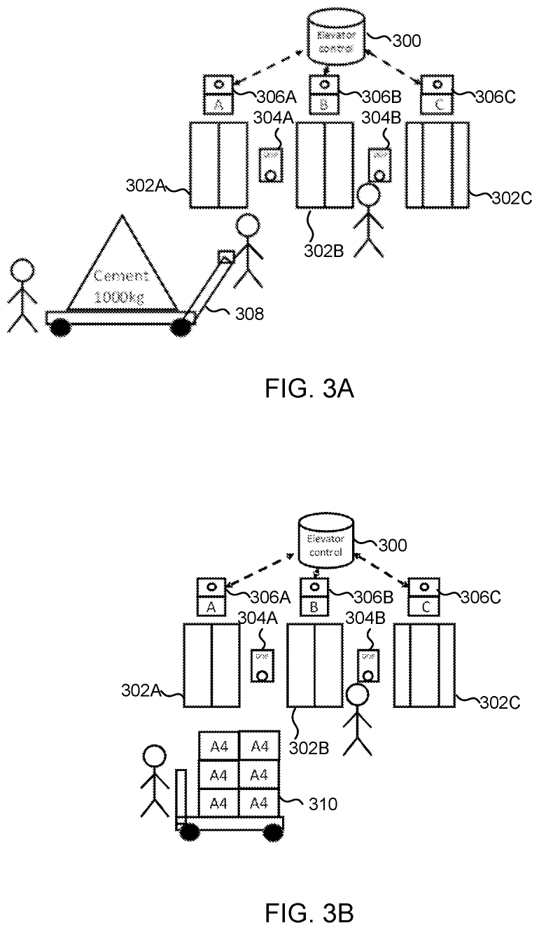

FIG. 3A illustrates an elevator lobby arrangement according to an example embodiment. FIG. 3A illustrates an example associated with a construction environment in which a heavy cement amount 308 is to be transported using an elevator. An elevator controller 300 is configured to control three elevators 302A, 302B, 302C. A camera may be integrated in at least one of the destination operating panels 304A, 304B and/or floor displays 306A-306C. The elevator system may be configured to detect the heavy object based on image data from at least one camera, allocate the elevator 302C and activate the at least one pre-emptive action associated with the allocated elevator car in the adjustment mode discussed above. In an example embodiment, the elevator system may be configured to identify a heavy object based on image data from at least one camera. The identification may thus be based, for example, an image recognition system or a machine vision system. The elevator system may identify, for example, based on the size of the object that the object is a “heavy object”. In another example embodiment, the elevator system may be configured to identify some identifier from the image data, for example, a text, an object identifier, a QR code, a bar code, and then based on the identifier obtain additional information about the weight of the object. In another example embodiment, the elevator system may be configured to obtain the indication of the heavy object from a system external to the elevator system.

FIG. 3B illustrates an elevator lobby arrangement according to another example embodiment. FIG. 3B illustrates an example associated with an office environment in which an office supply load 310 is to be transported using an elevator. Again, the elevator controller 300 is configured to control the three elevators 302A, 302B, 302C. Similarly to FIG. 3A, a camera may be integrated in at least one of the destination operating panels 304A, 304B and/or floor displays 306A-306C. The elevator system may be configured to detect the heavy object based on image data from at least one camera, allocate the elevator 302C and activate the at least one pre-emptive action associated with the allocated elevator car in the adjustment mode discussed above. In an example embodiment, the elevator system may be configured to identify a heavy object based on image data from at least one camera. The identification may thus be based, for example, an image recognition system or a machine vision system. The elevator system may be configured to identify, for example, based on the size of the object that the object is a “heavy object”. In another example embodiment, the elevator system may be configured to identify some identifier from the image data, for example, a text, an object identifier, a QR code, a bar code, and then based on the identifier obtain additional information about the weight of the object. In another example embodiment, the elevator system may be configured to obtain the indication of the heavy object from a system external to the elevator system.

At least some of the above discussed example embodiments may enable a solution in which a heavy object can be identified before it is loaded into an elevator car. When the object has been identified, a special operation mode may be activated for the elevator allocated to transport the object. The operation mode is configured to substantially maintain a vertical position of the elevator car in an elevator shaft when the heavy object is loaded into the elevator car. Thus, when the object is loaded into the elevator car, there will be no significant difference between the floor level of the elevator car and the floor level of the landing floor. This enables an easy travel, for example, for carts with wheels used to carry the heavy object.

Example embodiments may be implemented in software, hardware, application logic or a combination of software, hardware and application logic. The example embodiments can store information relating to various methods described herein. This information can be stored in one or more memories, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

All or a portion of the example embodiments can be conveniently implemented using one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments can be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

While there have been shown and described and pointed out fundamental novel features as applied to preferred embodiments thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. An elevator system, comprising:
means for obtaining an indication of a heavy object to be transported with the elevator system;
means for allocating an elevator car to transport the heavy object based on the indication;
means for activating, in response to the indication, at least one pre-emptive action associated with the allocated elevator car in an adjustment mode,
wherein the adjustment mode is configured to substantially maintain a vertical position of the elevator car in an elevator shaft when the heavy object is loaded into the elevator car.

2. The elevator system of claim 1, wherein the at least one pre-emptive action comprises an activation of a pawl device.

3. The elevator system of claim 1, wherein the adjustment mode comprises a precision mode, and wherein in the precision mode the means for activating are configured to, as the at least one pre-emptive action:
set a torque to a motor associated with the elevator car in order to keep the elevator car in place in the elevator shaft;
open machinery brakes at least partially; and
maintain the position of the elevator car in the elevator shaft with the motor based on information from at least one sensor, when the load carried by the elevator car changes.

4. The elevator system of claim 3, wherein the at least one sensor comprises at least one of a position sensor, a strain sensor, a torque sensor and a load sensor.

5. The elevator system of claim 1, wherein the means for obtaining the indication of the heavy object are configured to obtain the indication from a system external to the elevator system.

6. The elevator system of claim 1, wherein the means for obtaining comprise a sensor system configured to obtain image data provided by at least one camera and process the image data in order to identify the heavy object.

7. The elevator system of claim 6, wherein the sensor system is configured to identify the heavy object by identifying from the image data an identifier associated with the object.

8. The elevator system of claim 6, wherein the elevator system comprises the at least one camera.

9. The elevator system of claim 8, wherein the at least camera comprises a camera configured in at least one of the following:
a car operating panel;
a car display;
an elevator signalization device;
an info display;
a destination operating panel; and
a floor display.

10. The elevator system of claim 6, wherein the sensor system and the at least one camera are arranged in a single communication segment in the elevator system.

11. The elevator system of claim 6, wherein the sensor system comprises multiple analysis units configured in different locations in the elevator system.

12. The elevator system of claim 11, wherein an analysis unit of the multiple analysis units and at least one camera are arranged in a single communication segment in the elevator system.

13. The elevator system of claim 1, wherein the means for obtaining the indication of the heavy object are configured to obtain the indication together with an elevator call.

14. The elevator system of claim 13, wherein the indication comprise the mass of the object.

15. The elevator system of claim 1, wherein the means for obtaining the indication of the heavy object are configured to obtain the indication via a radio frequency transmission.

16. The elevator system of claim 2, wherein the adjustment mode comprises a precision mode, and wherein in the precision mode the means for activating are configured to, as the at least one pre-emptive action:
set a torque to a motor associated with the elevator car in order to keep the elevator car in place in the elevator shaft;
open machinery brakes at least partially; and
maintain the position of the elevator car in the elevator shaft with the motor based on information from at least one sensor, when the load carried by the elevator car changes.

17. The elevator system of claim 2, wherein the means for obtaining the indication of the heavy object are configured to obtain the indication from a system external to the elevator system.

18. The elevator system of claim 3, wherein the means for obtaining the indication of the heavy object are configured to obtain the indication from a system external to the elevator system.

19. The elevator system of claim 4, wherein the means for obtaining the indication of the heavy object are configured to obtain the indication from a system external to the elevator system.

20. The elevator system of claim 2, wherein the means for obtaining comprise a sensor system configured to obtain image data provided by at least one camera and process the image data in order to identify the heavy object.
